(19) United States
(12) Patent Application Publication
(10) Pub. No.: US 2023/0209666 A1
(43) Pub. Date: Jun. 29, 2023

(54) HEATING ASSEMBLY AND AEROSOL-GENERATION DEVICE

(71) Applicant: Jiangmen Moore Technology., Ltd, Jiangmen (CN)

(72) Inventors: Shidong WANG, Jiangmen (CN); Long CHEN, Jiangmen (CN)

(21) Appl. No.: 18/088,956

(22) Filed: Dec. 27, 2022

(30) Foreign Application Priority Data
Dec. 28, 2021 (CN) 202123360010.0

(51) Int. Cl. H05B 6/10

(52) U.S. Cl. CPC H05B 6/105

(57) ABSTRACT

A heating assembly for heating an aerosol-forming substrate includes: a bowl for carrying the aerosol-forming substrate, the bowl including a first bowl part and a second bowl part arranged along a height direction and connected to each other; and an electromagnetic coil having a first sub-coil and a second sub-coil connected in series. The first sub-coil is arranged surrounding the first bowl part, and causes the first bowl part to generate heat through electromagnetic induction. The second sub-coil does not electromagnetically induce the bowl.

### CROSS-REFERENCE TO PRIOR APPLICATION

Priority is claimed to Chinese Patent Application No. 202123360010.0, filed on Dec. 28, 2021, the entire disclosure of which is hereby incorporated by reference herein.

### FIELD

The present disclosure relates to the field of electronic vaporization technologies, and in particular, to a heating assembly and an aerosol-generation device.

### BACKGROUND

An aerosol-generation device is a device configured to heat and vaporize an aerosol-forming substrate to form an aerosol. Aerosol-generation devices have been widely applied in various fields, such as medical care, beauty care, and electronic cigarettes.

The power supply component is configured to supply power to a bowl. The heating assembly includes the bowl and a heating element. The bowl is configured to carry the aerosol-forming substrate. The heating element is configured to generate heat after being electrified to heat and vaporize the aerosol-forming substrate in the bowl by heat conduction.

However, the heat utilization of conventional heating assemblies is low.

### SUMMARY

In an embodiment, the present invention provides a heating assembly configured to heat an aerosol-forming substrate, heating assembly comprising: a bowl configured to carry the aerosol-forming substrate, the bowl comprising a first bowl part and a second bowl part arranged along a height direction and connected to each other; and an electromagnetic coil comprising a first sub-coil and a second sub-coil connected in series, wherein the first sub-coil is arranged surrounding the first bowl part, and is configured to cause the first bowl part to generate heat through electromagnetic induction, and wherein the second sub-coil does not electromagnetically induce the bowl.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an aerosol-generation device according to an embodiment of this application.

FIG. 2 is a simplified structural diagram of a heating assembly according to an embodiment of this application.

FIG. 3a is a simplified structural diagram of a heating assembly according to another embodiment of this application.

FIG. 3b a simplified structural diagram of a heating assembly according to still another embodiment of this application.

FIG. 4 is a simplified structural diagram of a heating assembly according to yet another embodiment of this application.

FIG. 5 is a schematic structural diagram of a planar coil part of a first sub-coil according to this application.

FIG. 6 is a simplified structural diagram of a heating assembly according to still yet another embodiment of this application.

### DETAILED DESCRIPTION

In an embodiment, the present invention provides a heating assembly and an aerosol-generation device to solve the problem of low heat utilization of conventional heating assemblies.

In an embodiment, the present invention provides a heating assembly, which is configured to heat an aerosol-forming substrate. The heating assembly includes: a bowl and an electromagnetic coil. The bowl is configured to carry the aerosol-forming substrate. The bowl includes a first bowl part and a second bowl part arranged along a height direction and connected to each other. The electromagnetic coil includes a first sub-coil and a second sub-coil connected in series. The first sub-coil is arranged surrounding the first bowl part, and is configured to cause the first bowl part to generate heat through electromagnetic induction. The second sub-coil does not electromagnetically induce the bowl.

The second bowl part does not include an electromagnetic induction material, and the second sub-coil is arranged surrounding the second bowl part.

The bowl includes a bowl body and an electromagnetic induction element, the bowl body does not include an electromagnetic induction material, and the electromagnetic induction element is arranged at a bottom part of the bowl body.

The electromagnetic induction element includes an annular side wall and a bottom wall and is sleeved on an outer side or an inner side of the bottom part of the bowl body.

The first sub-coil includes a hollow annular part surrounding the annular side wall of the electromagnetic induction element and a planar coil part arranged at a bottom part of the bottom wall of the electromagnetic induction element.

A material of the bowl body is quartz glass or ceramic.

A material of the second bowl part is quartz glass or ceramic, and a material of the first bowl part is an electromagnetic induction material.

A material of the bowl is an electromagnetic induction material, and the second sub-coil is arranged outside the bowl.

The second sub-coil is arranged at a bottom part of the bowl.

In order to resolve the foregoing technical problem, another technical solution adopted in this application is to provide an aerosol-generation device. The aerosol-generation device includes a housing, a heating assembly, and a power supply component. The heating assembly is arranged in the housing. The power supply component is arranged in the housing and electrically connected to an electromagnetic coil of the heating assembly. The heating assembly is the heating assembly provided above.

Beneficial effects of this application: Compared with conventional technologies, for the heating assembly and the aerosol-generation device provided in this application, the heating assembly includes the bowl and the electromagnetic coil, where the bowl is configured to carry the aerosol-forming substrate, the first sub-coil of the electromagnetic coil is arranged surrounding the first bowl part of the bowl to cause the first bowl part to generate heat through electromagnetic induction, and the second sub-coil does not electromagnetically induce the bowl. Because the aerosol-forming substrate is mainly concentrated in the first bowl part of the bowl after the aerosol-forming substrate is accommodated in the bowl, causing only the first bowl part of the bowl to generate heat can make the heat of the heating assembly more concentrated than the solution where the entire bowl is caused to generate heat, so that the heat utilization of the heating assembly can be effectively improved. In addition, with the additional provision of the second sub-coil that is not configured for electromagnetic induction and the connection of the second sub-coil to the first sub-coil to form a series circuit, series resonance is produced, and the power output is increased.

### REFERENCE NUMERALS

aerosol-generation device 100; housing 10; heating assembly 20; power supply component 30; bowl 21; first bowl part 21a; second bowl part 21b; bowl body 211; electromagnetic induction element 212; annular side wall 212a; bottom wall 212b; electromagnetic coil 22; first sub-coil 221; second sub-coil 222; insulating medium 23; hollow annular part 231; and bowl opening A.

The technical solutions in embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

The terms “first”, “second”, and “third” in this application are for purpose of description only, and shall not be understood as indicating or implying relative significance or implicitly indicating the number of indicated technical features. Therefore, features defining “first”, “second”, and “third” can explicitly or implicitly include at least one of the features. In the description of this application, “a plurality of” means at least two, such as two and three unless it is specifically defined otherwise. All directional indications (for example, upper, lower, left, right, front, and rear) in the embodiments of this application are merely used for explaining relative position relationships, movement situations, or the like between the various components in a specific posture (as shown in the accompanying drawings). If the specific posture changes, the directional indications change accordingly. In addition, the terms “include”, “have”, and any variant thereof are intended to cover a non-exclusive inclusion. For example, a process, method, system, product, or device that includes a series of steps or units is not limited to the listed steps or units, but further optionally includes a step or unit that is not listed, or further optionally includes another step or component that is intrinsic to the process, method, product, or device.

“Embodiment” mentioned in this specification means that particular features, structures, or characteristics described with reference to the embodiment may be included in at least one embodiment of this application. The term appearing at different positions of this specification may not refer to the same embodiment or an independent or alternative embodiment that is mutually exclusive with another embodiment. A person skilled in the art explicitly or implicitly understands that the embodiments described in this specification may be combined with other embodiments.

This application is further described in detail below with reference to the accompanying drawings and embodiments.

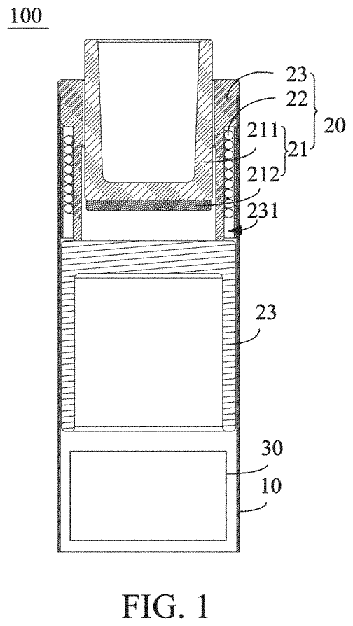

FIG. 1 is a schematic structural diagram of an aerosol-generation device according to an embodiment of this application. In this embodiment, an aerosol-generation device 100 is provided. The aerosol-generation device 100 may be applied in various fields, such as medical care, beauty care, electronic cigarettes, and household appliances, and is configured to heat and vaporize an aerosol-forming substrate to form an aerosol when being electrified. The aerosol-forming substrate is preferably a solid substrate, which may include one or more of powders, granules, fragmented strips, stripes, or sheets of one or more plant leaves such as vanilla leaves, tea leaves, mint leaves, or the like. Alternatively, the solid substrate may include an additional volatile aroma compound or a paste substance to be released when the substrate is heated. Certainly, the aerosol-forming substrate may also be a liquid substrate, such as an oil or a liquid medicine that containing an aroma component.

Specifically, as shown in FIG. 1, the aerosol-generation device 100 includes a housing 10, a heating assembly 20, and a power supply component 30. Both the heating assembly 20 and the power supply component 30 are arranged in the housing 10. The power supply component 30 is connected to the heating assembly 20, and is configured to supply power to the heating assembly 20.

The power supply component 30 may specifically be a lithium-ion battery. Reference may be made to any one of the following detailed descriptions about the heating assembly 20 for the specific structure and function of the heating assembly 20.

Certainly, in a specific embodiment, the aerosol-generation device 100 further includes other components of a conventional aerosol-generation device 100. These components have specific structures and functions same as or similar to those of corresponding components of aerosol-generation devices 100 in conventional technologies, and can achieve the same or similar technical effects. Reference may be made to conventional technologies for details, which will not be repeated herein.

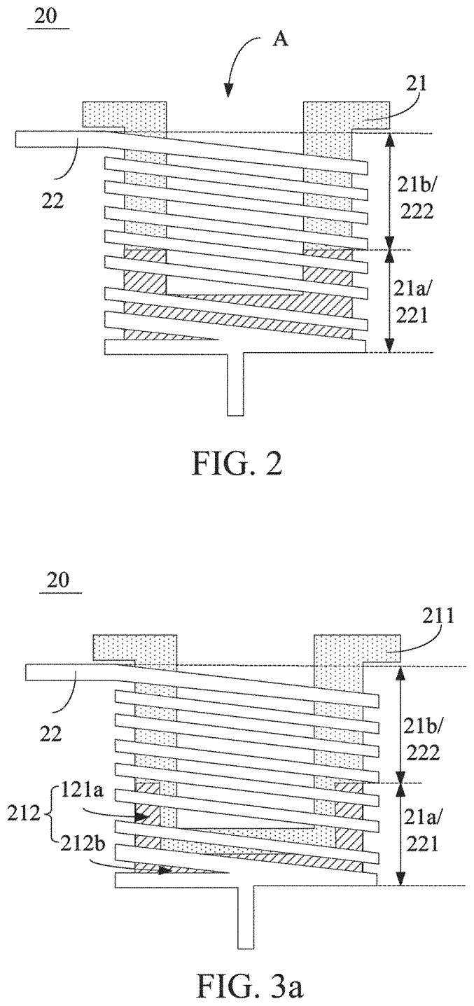

FIG. 2 is a simplified schematic structural diagram of a heating assembly according to an embodiment of this application. The heating assembly 20 specifically includes a bowl 21 and an electromagnetic coil 22. The bowl 21 is configured to carry an aerosol-forming substrate. The bowl 21 includes a first bowl part 21a and a second bowl part 21b arranged along a height direction and connected to each other. The power supply component 30 is specifically connected to the electromagnetic coil 22 to supply power to the electromagnetic coil 22. The electromagnetic coil 22 specifically includes a first sub-coil 221 and a second sub-coil 222 connected in series and extending around along the height direction of the bowl 21. The first sub-coil 221 is arranged surrounding the first bowl part 21a, and is configured to cause the first bowl part 21a to generate heat through electromagnetic induction. The second sub-coil 222 does not electromagnetically induce the bowl 21. Because the aerosol-forming substrate is mainly concentrated in the first bowl part 21a of the bowl 21, that is, the position on the bowl 21 close to a bottom wall, after the aerosol-forming substrate is accommodated in the bowl 21, causing only the first bowl part 21a of the bowl 21 to generate heat can make the heat of the heating assembly 20 more concentrated than the solution where the entire bowl 21 is caused to generate heat, so that the heat utilization of the heating assembly 20 can be effectively improved. In addition, with the additional provision of the second sub-coil 222 that is not configured for electromagnetic induction and the connection of the second sub-coil 222 without a load to the first sub-coil 221 with a load to form a series circuit, series resonance is produced, and the power output is increased.

A height of the first sub-coil 221 is one third to one fourth of a total height of the electromagnetic coil 22. Certainly, the height of the first sub-coil 221 may also have other values, for example, one half or two fifths of the total height of the electromagnetic coil 22, which is not limited in this application.

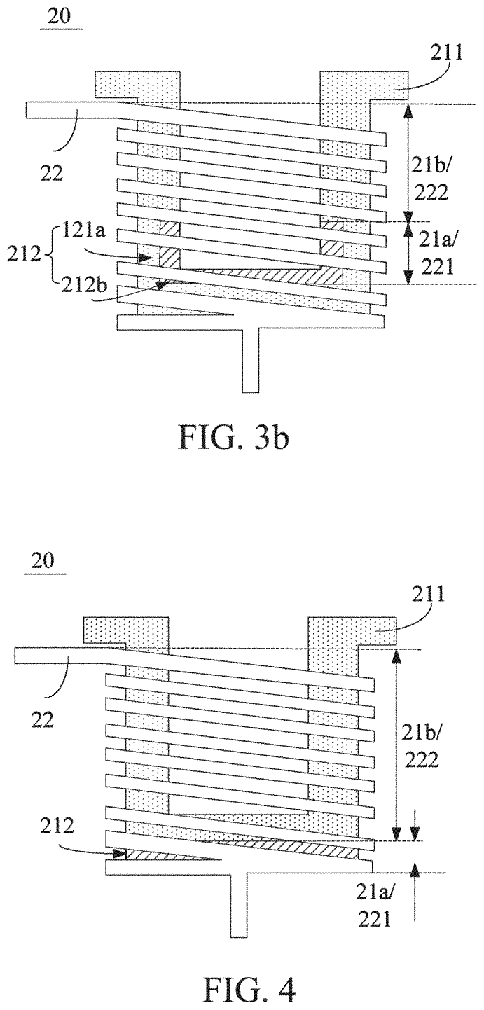

In an embodiment, as shown in FIG. 2, the bottom part of the bowl 21 is defined as a bottom wall 212b of the bowl 21; or the bottom part of the bowl 21 is defined as the bottom wall 212b of the bowl 21 and a part of the side wall close to the bottom wall 212b of the bowl 21. The first bowl part 21a is constructed as the bottom part of the bowl 21, and the second bowl part 21b is constructed as a part of the bowl 21 close to a bowl opening A. A material of the first bowl part 21a is an electromagnetic induction material such as stainless steel, titanium alloy, titanium, iron, or nickel. After the first sub-coil 221 is electrified, the first bowl part 21a is electromagnetically induced by the first sub-coil 221 to generate heat, to heat and vaporize the aerosol-forming substrate in the bowl 21. A material of the second bowl part 21b does not include an electromagnetic induction material, and the second sub-coil 222 is specifically arranged surrounding the second bowl part 21b, so that after the second sub-coil 222 is electrified, the second bowl part 21b is hardly electromagnetically induced to generate heat. In this way, the heat is mainly concentrated in the first bowl 21a, thereby improving the heat utilization. Specifically, the material of the second bowl part 21b may be quartz glass or ceramic, so that the heat loss of the first bowl part 21a can be reduced. In another embodiment, refer to FIG. 3a and FIG. 3b. FIG. 3a is a simplified structural diagram of a heating assembly according to another embodiment of this application. FIG. 3b is a simplified structural diagram of a heating assembly according to still another embodiment of this application. The bowl 21 specifically includes a bowl body 211 and an electromagnetic element 212.

The bowl body 211 is configured to carry the aerosol-forming substrate. The bowl body 211 does not include an electromagnetic induction material. A material of the bowl body 211 may specifically be quartz glass or ceramic. The electromagnetic induction element 212 is arranged at a bottom part of the bowl body 211.

In a specific embodiment, as shown in FIG. 3a, the bottom part of the bowl body 211 is defined as a bottom wall 212b of the bowl body 211 and a part of the side wall close to the bottom wall 212b of the bowl body 211. In this embodiment, the electromagnetic induction element 212 includes an annular side wall 212a and a bottom wall 212b, that is, the electromagnetic induction element 212 is groove-shaped.

The annular side wall 212a of the electromagnetic induction element 212 is arranged surrounding the part of the side wall close to the bottom wall of the bowl body 211. The bottom wall 212b of the electromagnetic induction element 212 covers a bottom part of the bottom wall 212b of the bowl body 211. In a specific embodiment, the electromagnetic induction element 212 may be sleeved on an inner side (referring to FIG. 3b) or an outer side (referring to FIG. 3a) of the bowl body 211. It can be understood that, in the specific embodiment, the part of the bowl body 211 surrounded by the electromagnetic induction element 212 and the electromagnetic induction element 212 are constructed as the first bowl part 21a of the bowl 21, and the part of the bowl body 211 exposed out of the electromagnetic induction element 212 is constructed as the second bowl part 21b of the bowl 21.

In another specific embodiment, refer to FIG. 4. FIG. 4 is a simplified structural diagram of a heating assembly according to yet another embodiment of this application. The electromagnetic induction element 212 is arranged at a bottom part of the bottom wall of the bowl body 211 and matches with the size of the bottom wall of the bowl body 211. In this embodiment, the electromagnetic induction element 212 may specifically be a metal mesh sheet. It can be understood that, in the specific embodiment, the electromagnetic induction element 212 is constructed to form the first bowl part 21a of the bowl 21, and the bowl body 211 is constructed to form the second bowl part 21b of the bowl 21.

In a specific embodiment, the first sub-coil 221 includes only the hollow annular part 231 arranged surrounding the first bowl part 21a. In this way, the first sub-coil 221 does not occupy a bottom space of the bottom wall 212b of the bowl 21 while ensuring that the first bowl part 21a can generate heat through electromagnetic induction. In this way, elements such as a temperature sensor, a current sensor, and the like may further be arranged at the bottom part of the bottom wall 212b of the bowl 21, thereby making proper use of the space.

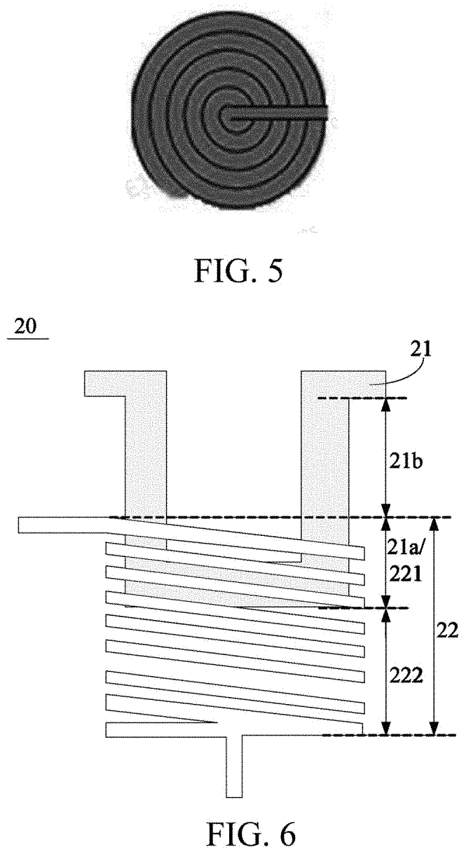

Certainly, in some other embodiments, refer to FIG. 5. FIG. 5 is a schematic structural diagram of a planar coil part of a first sub-coil according to this application. The first sub-coil 221 may further include a planar coil part. The planar coil part is arranged at the bottom part of the bottom wall 212b of the electromagnetic induction element 212. It can be understood that, when the electromagnetic induction element 212 is of the structure shown in FIG. 4, the planar coil part is arranged at a bottom part of the electromagnetic induction element 212, but this application is not limited thereto.

In an embodiment, refer to FIG. 6. FIG. 6 is a simplified structural diagram of a heating assembly according to still yet another embodiment of this application. At least the material of the first bowl part 21a of the bowl 21 is an electromagnetic induction material such as stainless steel or titanium alloy. The first sub-coil 221 surrounds the first bowl part 21a of the bowl 21. The second sub-coil 222 is arranged outside the bowl 21. The second sub-coil 222 being arranged outside the bowl 21 refers to that the second sub-coil 222 does not surround the bowl 21. For example, the second sub-coil 222 is arranged at the bottom part of the bowl 21 (referring to FIG. 6); or, the second sub-coil 222 is arranged on one side of the bowl 21; or the second sub-coil 222 is arranged at a top part of the bowl 21, as long as the second sub-coil 222 and the first sub-coil 221 are connected in series through a wire. In this case, it can be ensured that the heat of the heating assembly 20 is concentrated in the first bowl part 21a, thereby improving the heat utilization. In addition, with the additional provision of the second sub-coil 222 that is not configured for electromagnetic induction and the connection of the second sub-coil 222 to the first sub-coil 221 to form a series circuit, series resonance is produced, and the power output is increased. Certainly, in this embodiment, the material of the entire bowl 21 may be an electromagnetic induction material such as stainless steel or titanium alloy.

Certainly, in a specific embodiment, as shown in FIG. 1, the heating assembly 20 may further include an insulating medium 23. The insulating medium 23 is constructed to be arranged surrounding the bowl 21 to reduce the heat loss in the bowl 21. Specifically, a part of the insulating medium 23 is arranged surrounding a circumferential side wall of the bowl 21, the insulating medium 23 includes the hollow annular part 231 along the height direction of the bowl 21, and at least a part of the electromagnetic coil 22 is accommodated in the hollow annular part 231, so that the position of the electromagnetic coil 22 is limited by the hollow annular part 231. In a specific embodiment, the bottom part of the bowl 21 is also provided with a part of the insulating medium 23, to further reduce the heat loss in the bowl 21.

The heating assembly 20 provided in this application includes the bowl 21 and the electromagnetic coil, where the bowl 21 is configured to carry the aerosol-forming substrate, the first sub-coil 221 of the electromagnetic coil 22 is arranged surrounding the first bowl part 21a of the bowl 21 to cause the first bowl part 21a to generate heat through electromagnetic induction, and the second sub-coil 20 does not electromagnetically induce the bowl 21. Because the aerosol-forming substrate is mainly concentrated in the first bowl part 21a of the bowl 21 after the aerosol-forming substrate is accommodated in the bowl 21, causing only the first bowl part of the bowl 21 to generate heat can make the heat of the heating assembly 20 more concentrated than the solution where the entire bowl 21 is caused to generate heat, so that the heat utilization of the heating assembly 20 can be effectively improved. In addition, with the additional provision of the second sub-coil 222 that is not configured for electromagnetic induction and the connection of the second sub-coil 222 to the first sub-coil 221 to form a series circuit, series resonance is produced, and the power output is increased.

The foregoing descriptions are merely implementations of this application, and the patent scope of this application is not limited thereto. All equivalent structure or process changes made according to the content of this specification and accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating assembly configured to heat an aerosol-forming substrate, heating assembly comprising:
a bowl configured to carry the aerosol-forming substrate, the bowl comprising a first bowl part and a second bowl part arranged along a height direction and connected to each other; and
an electromagnetic coil comprising a first sub-coil and a second sub-coil connected in series,
wherein the first sub-coil is arranged surrounding the first bowl part, and is configured to cause the first bowl part to generate heat through electromagnetic induction, and
wherein the second sub-coil does not electromagnetically induce the bowl.

2. The heating assembly of claim 1, wherein the second bowl part does not comprise an electromagnetic induction material, and
wherein the second sub-coil is arranged surrounding the second bowl part.

3. The heating assembly of claim 2, wherein the bowl comprises a bowl body and an electromagnetic induction element,
wherein the bowl body does not comprise an electromagnetic induction material, and
wherein the electromagnetic induction element is arranged at a bottom part of the bowl body.

4. The heating assembly of claim 3, wherein the electromagnetic induction element comprises an annular side wall and a bottom wall, and is sleeved on an outer side or an inner side of the bottom part of the bowl body.

5. The heating assembly of claim 4, wherein the first sub-coil comprises a hollow annular part surrounding the annular side wall of the electromagnetic induction element and a planar coil part arranged at a bottom part of the bottom wall of the electromagnetic induction element.

6. The heating assembly of claim 3, wherein a material of the bowl body comprises quartz glass or ceramic.

7. The heating assembly of claim 2, wherein a material of the second bowl part comprises quartz glass or ceramic, and
wherein a material of the first bowl part comprises an electromagnetic induction material.

8. The heating assembly of claim 1, wherein a material of the bowl comprises an electromagnetic induction material, and
wherein the second sub-coil is arranged outside the bowl.

9. The heating assembly of claim 8, wherein the second sub-coil is arranged at a bottom part of the bowl.

10. An aerosol-generation device, comprising:
a housing;
the heating assembly of claim 1 arranged in the housing; and
a power supply component arranged in the housing and electrically connected to an electromagnetic coil of the heating assembly.
